(19) United States
(12) Patent Application Publication
(10) Pub. No.: US 2025/0218079 A1
(43) Pub. Date: Jul. 3, 2025

(54) INFORMATION PROCESSING APPARATUS, LAYOUT ASSISTANCE METHOD, AND STORAGE MEDIUM

(71) Applicant: NEC CORPORATION, Minato-ku, Tokyo (JP)

(72) Inventors: Ichiro IGURA, Tokyo (JP); Naoki KATOH, Tokyo (JP); Takahiro TOIZUMI, Tokyo (JP); Akiyuki ISHIYAMA, Tokyo (JP); Yasuhiko AWASAWA, Tokyo (JP)

(73) Assignee: NEC CORPORATION, Minato-ku, Tokyo (JP)

(21) Appl. No.: 18/850,149

(22) PCT Filed: Mar. 28, 2022
(86) PCT No.: PCT/JP2022/014965

§ 371 Date: Sep. 24, 2024

(51) Int. Cl. G06T 11/60

(52) U.S. Cl. CPC G06T 11/60

(57) ABSTRACT

To achieve labor savings in generating a layout, an information processing apparatus (1) includes: a layout decision section (11) that decides, for each of elements to be arranged in an object area of a layout, a position and an assignment area of the element in the object area; and an adjustment section (12) that makes an adjustment to the assignment area so that a predetermined layout condition set to the object area is satisfied.

### TECHNICAL FIELD

The present invention relates to an information processing apparatus and the like for assisting in generating the layouts for placing articles on, for example, newspapers and magazines for print pages or for web pages.

### BACKGROUND ART

Laying out articles on print pages of newspapers, magazines, and the like, has conventionally been performed manually, and a technique for saving labor and improving efficiency of such an operation is required. One such technique is, for example, an organizing and compositing apparatus disclosed in Patent Literature 1 below. This organizing and compositing apparatus displays a rough layout that indicates a layout of news frames on a newspaper print page and accepts an operator's layout designation, to facilitate generating or changing the rough layout.

### CITATION LIST

### Patent Literature

### Patent Literature 1

Japanese Patent Application Publication Tokukaihei No. 11-154239

### SUMMARY OF INVENTION

### Technical Problem

The organizing and compositing apparatus disclosed in Patent Literature 1 merely allows an operation that has been conventionally carried out on an assignment sheet to be carried out on a screen, so that it is necessary to manually determine assignment areas of news articles, and a layout of a headline, a photo, and any other item in each assignment area. Thus, there is a demand for a technique capable of automatically carrying out decisions in generating a layout as well.

For example, it is possible to generate a layout decision model for deciding an optimum article layout by performing learning of article layouts by using existing print pages as training data. Use of such a model makes it possible to achieve labor savings in generating a layout.

However, in many cases, a print page for which a layout is generated is attached with a layout condition and it is difficult to automatically generate a layout that satisfies such a layout condition. For example, there may be set a layout condition that an edge of an article is required to be coincide with a delimitation position, such as a column or a row, or a frame, defined in a print page. It is difficult to generate a layout satisfying such a layout condition even with use of the layout decision model. Thus, ultimately, it is necessary to make a manual adjustment, so that there has been problems in that sufficient labor savings cannot be achieved.

An example aspect of the present invention has been made in view of these problems, and an example object thereof is to provide a technique for achieving labor savings in generating a layout.

### Solution to Problem

An information processing apparatus in accordance with an example aspect of the present invention includes: layout decision means for deciding, for each of elements to be arranged in an object area of a layout, a position and an assignment area of the element in the object area; and adjustment means for making an adjustment to the assignment area so that a predetermined layout condition set to the object area is satisfied.

A layout assistance method in accordance with an example aspect of the present invention includes: deciding, by at least one processor, for each of elements to be arranged in an object area of a layout, a position and an assignment area of the element in the object area; and making, by the at least one processor, an adjustment to the assignment area so that a predetermined layout condition set to the object area is satisfied.

A layout assistance program in accordance with an example aspect of the present invention causes a computer to function as: layout decision means for deciding, for each of elements to be arranged in an object area of a layout, a position and an assignment area of the element in the object area; and adjustment means for making an adjustment to the assignment area so that a predetermined layout condition set to the object area is satisfied.

### Advantageous Effects of Invention

According to an example aspect of the present invention, it is possible to achieve labor savings in generating a layout.

### BRIEF DESCRIPTION OF DRAWINGS

FIG. 1 is a block diagram illustrating the configuration of an information processing apparatus in accordance with a first example embodiment of the present invention.

FIG. 2 is a flowchart illustrating the flow of a layout assistance method in accordance with the first example embodiment of the present invention.

FIG. 3 is a diagram illustrating an example of a layout adjustment carried out by using a layout assistance method in accordance with a second example embodiment of the present invention.

FIG. 4 is a block diagram illustrating the configuration of an information processing apparatus in accordance with the second example embodiment of the present invention.

FIG. 5 is a flowchart illustrating the flow of the layout assistance method in accordance with the second example embodiment of the present invention.

FIG. 6 is a diagram illustrating an example of a layout adjustment carried out by using a layout assistance method in accordance with a third example embodiment of the present invention.

FIG. 7 is a block diagram illustrating the configuration of an information processing apparatus in accordance with the third example embodiment of the present invention.

FIG. 8 is a diagram illustrating an example of a computer that executes instructions of a program which is software implementing the functions of the apparatuses in accordance with the example embodiments of the present invention.

### EXAMPLE EMBODIMENTS

### First Example Embodiment

The following description will discuss a first example embodiment of the present invention in detail with reference to the drawings. The present example embodiment is basic to example embodiments that will be described later.

### Configuration of Information Processing Apparatus 1

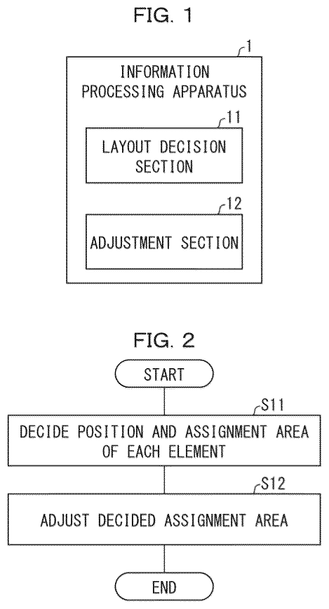

The following description will discuss the configuration of an information processing apparatus 1 in accordance with the present example embodiment with reference to FIG. 1. FIG. 1 is a block diagram illustrating the configuration of the information processing apparatus 1. As illustrated in FIG. 1, the information processing apparatus 1 includes a layout decision section (layout decision means) 11 and an adjustment section 12 (adjustment means).

The layout decision section 11 decides, for each of elements to be arranged in an object area of a layout, the position and the assignment area of the element in the object area.

The adjustment section 12 makes an adjustment to the assignment area decided by the layout decision section 11 so that a predetermined layout condition set to the object area is satisfied.

As described in the foregoing, the information processing apparatus 1 in accordance with the present example embodiment employs a configuration including: the layout decision section 11 that decides, for each of elements to be arranged in an object area of a layout, the position and the assignment area of the element in the object area; and the adjustment section 12 that makes an adjustment to the assignment area so that a predetermined layout condition set to the object area is satisfied. With this configuration, it is possible to achieve an example advantage of being capable of achieving labor savings in generating a layout.

### Layout Assistance Program

The abovementioned functions of the information processing apparatus 1 may be implemented by a program. An assistance program in accordance with the present example embodiment causes a computer to function as: the layout decision section 11 that decides, for each of elements to be arranged in an object area of a layout, the position and the assignment area of the element in the object area; and the adjustment section 12 that makes an adjustment to the assignment area so that a predetermined layout condition set to the object area is satisfied. With this assistance program, it is possible to achieve an example advantage of being capable of achieving labor savings in generating a layout.

### Flow of Layout Assistance Method

The following description will discuss the flow of a layout assistance method in accordance with the present example embodiment with reference to FIG. 2. FIG. 2 is a flowchart illustrating the flow of the layout assistance method. It should be noted that steps of the assistance method may be carried out by a processor of the information processing apparatus 1 or by a processor of another apparatus. Alternatively, the steps may be carried out by processors provided in respective different apparatuses.

In S11, at least one processor decides, for each of elements to be arranged in an object area of a layout, the position and the assignment area of the element in the object area.

In S12, the at least one processor makes an adjustment to the assignment area decided in S11 so that a predetermined layout condition set to the object area is satisfied.

As described in the foregoing, the layout assistance method in accordance with the present example embodiment includes: deciding, by at least one processor, for each of elements to be arranged in an object area of a layout, the position and the assignment area of the element in the object area; and making, by the at least one processor, an adjustment to the decided assignment area so that a predetermined layout condition set to the object area is satisfied. With this assistance method, it is possible to achieve an example advantage of being capable of achieving labor savings in generating a layout.

### Second Example Embodiment

In a second example embodiment, an example will be described in which the object area of the layout is a print page of a newspaper, and the elements to be arranged in the object area is articles of the newspaper. Of course, a layout assistance method and the like described in the second example embodiment are not limited to generation of the layout of the articles on the print page of the newspaper, and may be applied to generation of any layout of any elements in any object area. Therefore, the “print page of a newspaper” in the following description can be read as any “object area”, and the “articles” in the following description can be read as any “elements” (elements to be arranged in an object area).

### Outline

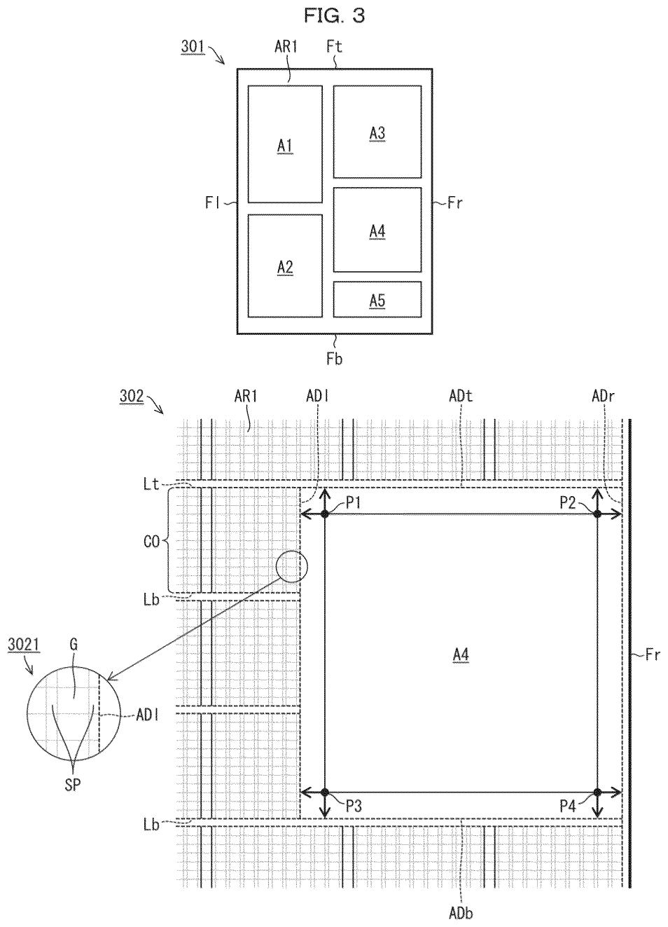

The following description will discuss the outline of the layout assistance method in accordance with the present example embodiment with reference to FIG. 3. FIG. 3 is a diagram illustrating an example of a layout adjustment carried out by using the layout assistance method in accordance with the present example embodiment (hereinafter, referred to as “the present method”). More specifically, in FIG. 3, 301 denotes an example of a layout of articles on a newspaper print page, and 302 denotes an example of the layout adjustment.

In the print page depicted in 301 of FIG. 3, five articles A1 to A5 are laid out in an area AR1, which is the object area of the layout. As described above, in the present method, first, for each of the articles A1 to A5 to be arranged in the area AR1, which is the object area of the layout, the position and the assignment area thereof in the area AR1 are decided. Here, the top edge, the bottom edge, the left edge, and the right edge of the area AR1 are defined by frame lines Ft, Fb, Fl, and Fr, respectively.

Next, in the present method, the layout of the articles A1 to A5 is adjusted so that the predetermined layout condition set to the area AR1 is satisfied. Here, more specifically, the layout adjustment refers to an adjustment of the assignment area of each article A1 to A5.

In the example of FIG. 3, the following four layout conditions are set.
(1) The top edge of each article coincides with the top edge of a row defined in the area AR1.
(2) The bottom edge of each article coincides with the lower edge of a row defined in the area AR1.
(3) The left edge of each article coincides with the left edge of a text line, which extends vertically, defined in the area AR1.
(4) The right edge of each article coincides with the right edge of a text line, which extends vertically, defined in the area AR1.

Layout conditions may indicate delimitation positions of the assignment area of an article; in these layout conditions (1) to (4), the top edge of a row, the bottom edge of a row, the left edge of a text line, and the right edge of a text line serve as the delimitation positions. By applying such layout conditions indicating the delimitation positions for the assignment areas of articles, it is possible to generate a layout with a superior appearance in which the articles are arranged along the delimitation positions.

In FIG. 3, as illustrated in a partial enlarged view 3021, ruled-off squares G are aligned in the area AR1, and the vertically arranged squares G form the “text line” or “line” mentioned above. Basically, each square G receives one letter. In addition, to the left and right of the squares G, spaces SP are provided to form line gaps. Each line ends when being fed with a predetermined number of characters. This forms a row CO having a predetermined height. In FIG. 3, the top edge and the bottom edge of a row are indicated by broken lines Lt and Lb, respectively. It should be noted that, although FIG. 3 illustrates a layout for sentences written vertically, the present method is also applicable to a layout for sentences written horizontally.

In FIG. 3, 302 denotes an example of the adjustment to the assignment area of the article A4. In 302, points P1 to P4 indicate four vertexes of a rectangular assignment area that has been assigned to the article A4 before the adjustment. Broken lines ADt, ADb, ADl, and ADr indicate the top edge, the bottom edge, the left edge, and the right edge of the assignment area after the adjustment, respectively.

As illustrated in 302 in FIG. 3, the broken line ADt is aligned over the broken line Lt indicating the top edge of the row, which satisfies the condition (1) described above. The broken line ADb is aligned over the broken line Lb indicating the bottom edge of the row, which satisfies the condition (2) described above. The broken line ADl coincides with the right edge of a space SP, that is, the left edge of an adjacent line, which is present to the right of the spaces SP, as illustrated in 3021 in FIG. 3, which satisfies the condition (3) described above. The broken line ADr coincides with the right edge of the rightmost line defined in the area AR1, which satisfies the condition (4) described above.

Here, regarding the layout conditions (3) and (4) described above, adjustments in the lateral direction may be carried out in a manner such that the edges of the assignment area after the adjustment do not extend inside the ruled-off squares G. For example, although the ADl illustrated in 3021 in FIG. 3 is set to extend on the right edge of the spaces SP, which are present to the right of the squares G, the ADl may be set to extend on the left edge of these spaces SP. Thus, in adjustments in the lateral direction, the assignment area may be adjusted to include therein the spaces SP or may be adjusted not to include therein the spaces SP. For example, the right edge of the assignment area may be adjusted so that the assignment area does not include the spaces SP, and the left edge of the assignment area may be adjusted so that the assignment area includes the spaces SP.

In the present method, by carrying out the adjustments as described in the foregoing, a layout that satisfies the layout conditions is automatically generated. This achieves labor savings in generating a layout. Although it is also possible to have a layout satisfy the layout conditions at an initial step of generation of an article layout, in such a case, it is necessary to apply a layout technique that is specialized for a specific layout condition, and this disadvantageously reduces the versatility. For example, when layout conditions for local news pages and those of economic news pages are difference, it is necessary to prepare layout techniques for local news pages and economic news pages.

In this regard, the present method does not require a precise layout at the initial step of the generation of the article layout, so that it is possible to apply a highly versatile layout technique that is not specialized for a specific layout condition. For example, even in a case where layout conditions for local news pages and those of economic news pages are different, it is possible to automatically generate a layout satisfying the layout conditions for the local news pages and a layout satisfying the layout conditions for the economic news pages by generating a layout for the local news pages and a layout for the economic news pages using the same technique, followed by adjustments to each layout.

### Conditions for Adjustment

There are several ways of making adjustments for satisfying layout conditions. For example, in 302 in FIG. 3, it is also possible to have the top edge of the assignment area coincide with the top edge of a row by making a downward adjustment to the top edge of the assignment area of the article A4. Thus, it is necessary to determine the conditions for adjustments in advance.

For example, a condition that an adjustment is made in such a manner as to expand the assignment area of an article while minimizing the amount of adjustment may be determined in advance. However, if the top or bottom edge of the assignment area before the adjustment is in the space between adjacent rows and the assignment area is adjusted under this condition, the assignment area is expanded by about one row, and the assignment area after the adjustment might be too large. Thus, when the top or bottom edge of the assignment area before the adjustment is in the space between adjacent rows, it is preferable to adjust the assignment area of the article by reducing the assignment area.

Similarly, for the adjustment in the width direction of the assignment area of an article, a condition that the adjustment is made in such a manner as to expand the assignment area of an article while minimizing the amount of adjustment may be determined in advance. In addition to this condition, when the right or left edge of the assignment area before the adjustment is in a line gap (space SP in 3021 in FIG. 3), a condition that an adjustment is made in such a manner as to reduce the assignment area may be determined in advance.

Further, an assignment area that is adjacent to any of the frame lines Ft, Fb, Fl, and Fr, which define the outer periphery of the area AR1, may be adjusted with reference to these frame lines. For example, the assignment area assigned to the article A4 in FIG. 3 is adjacent to the frame line Fr. Thus, the right edge of the assignment area may be adjusted to the position of the right edge of the text line closest to the frame line Fr (or the right edge of the adjacent spaces SP present to the right of the closest text line). By doing this, it is possible to make adjustments so that each assignment areas is aligned along the outer periphery of the area AR1, and it is possible to generate a layout with a superior appearance in which each article placed along the outer periphery of the area AR is aligned along the outer periphery thereof.

### Configuration of Information Processing Apparatus 2

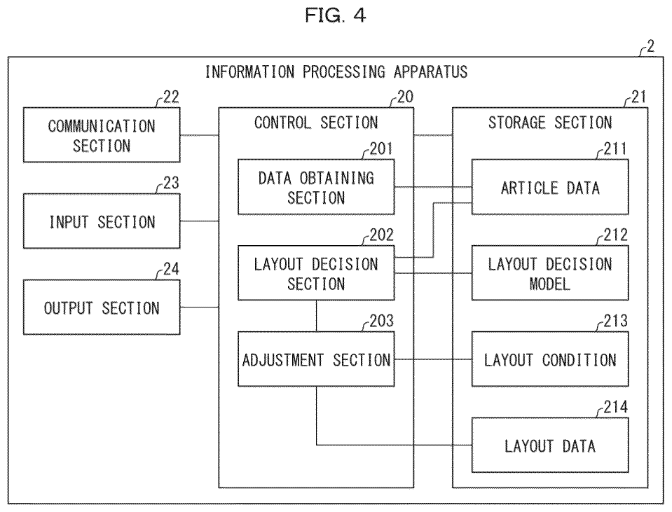

The following description will discuss the configuration of an information processing apparatus 2 in accordance with the present example embodiment with reference to FIG. 4. FIG. 4 is a block diagram illustrating the configuration of the information processing apparatus 2. As illustrated in the figure, the information processing apparatus 2 includes: a control section 20 that centrally controls each section of the information processing apparatus 2; and a storage section 21 that stores various kinds of data used by the information processing apparatus 2. The information processing apparatus 2 also includes: a communication section 22 configured to allow communication between the information processing apparatus 2 and other apparatuses; an input section 23 that accepts a user's input operation to the information processing apparatus 2; and an output section 24 via which the information processing apparatus 2 outputs data.

Further, the control section 20 includes a data obtaining section 201, a layout decision section (layout decision means) 202, and an adjustment section (adjustment means) 203. The storage section 21 stores therein article data 211, a layout decision model 212, a layout condition 213, and layout data 214.

The data obtaining section 201 obtains the article data 211. The article data 211 indicates an article to be arranged in a layout. In addition to information indicating articles to be arranged in a newspaper print page, the article data 211 may include various kinds of information for use in deciding an article layout, that is, information set as explanatory variables of the layout decision model 212 to be described later.

For example, the article data 211 may include information indicating the coordinates of the four corners of a newspaper print page or the width and height of the newspaper print page. Further, for example, the article data 211 may include information associated with a print page (e.g., whether the page is an economic or local news page). Further, for example, the article data 211 may include information associated with each constituent element (e.g., the text, a photo, the headline, etc.) included in an article (e.g., information indicating the contents, size, volume, category, or importance of the article). For example, the data obtaining section 201 may obtain the article data 211 inputted via the input section 23 or may obtain the article data 211 from another apparatus via the communication section 22.

The layout decision section 202 decides the layout of articles on a newspaper print page, that is, the position and the assignment area of each article arranged on the newspaper print page. Specifically, the layout decision section 202 decides, using the layout decision model 212, the position and the assignment area of each article indicated in the article data 211 obtained by the data obtaining section 201.

The layout decision model 212 is a model that is generated by performing machine learning based on relationship between (i) various kinds of information associated with an arrangement of an article, serving as explanatory variables, and (ii) the position and the assignment area in which the article is to be arranged, serving as objective variables. By receiving as input the various kinds of information associated with the arrangement of the article indicated in the article data 211, the layout decision model 212 outputs the information indicating the position and the assignment area in which the article is to be arranged.

The adjustment section 203 makes an adjustment to the assignment area decided by the layout decision section 202 so that a predetermined layout condition 213 set to the newspaper print page is satisfied. The adjustment section 203 generates layout data 214 in which this adjustment is reflected in the layout decided by the layout decision section 202. Here, the layout conditions and the adjustment method will not be repeated since they are as described under the item “Outline” described above.

As described in the foregoing, the information processing apparatus 2 in accordance with the present example embodiment includes: the layout decision section 202 that decides, for each article (elements to be arranged in a layout) to be arranged in a newspaper print page, which is an object area of a layout, the position and the assignment area of the article in the newspaper print page; and the adjustment section 203 that makes an adjustment to the assignment area decided by the layout decision section 202 so that a predetermined layout condition 213 set to the newspaper print page is satisfied. Thus, with the information processing apparatus 2 in accordance with the present example embodiment, it is possible to achieve an example advantage of being capable of achieving labor savings in generating a layout.

Further, as described above, the information processing apparatus 2 in accordance with the present example embodiment, the layout decision section 202 decides the position and the assignment area of the article by using the layout decision model 212 generated by performing machine learning based on a relationship between (i) various kinds of information associated with an arrangement of the article (element to be arranged in a layout), serving as explanatory variables, and (ii) the position and the assignment area in which the article is to be arranged, serving as objective variables. Thus, with the information processing apparatus 2 in accordance with the present example embodiment, it is possible to achieve an example advantage of being capable of deciding a reasonable layout based on the results of the learning, in addition to the example advantage achieved by the information processing apparatus 1 in accordance with the first example embodiment.

It is desirable that the explanatory variables include at least the shape and size of a newspaper print page, which is the object area in which the articles are to be arranged. For example, the coordinates of the four corners of a newspaper print page or the width and height of the newspaper print page may be used as the explanatory variables. Further, the explanatory variables may include information indicating the contents, size, and volume of each constituent element (e.g., the text, a photo, the headline, etc.) included in an article. In addition, for example, information indicating the category or the importance of an article may be included in the explanatory variables. These pieces of information may be included in the article data 211. The abovementioned objective variables may be information indicating the position and the assignment area of each article in the object area. For example, the position coordinates indicating the positions of the four corners of each article may be used as the objective variables.

As described above in the item “Outline”, the present method does not require a precise layout at the initial step of generation of the article layout, so that it is possible to apply a highly versatile layout decision model 212 that is not specialized for a specific layout condition. For example, the layout decision model 212 that is generated by performing machine learning, using training data generated by using actual newspaper print pages with different layout conditions (i.e., data of the newspaper print pages in which the abovementioned explanatory variables and the abovementioned objective variables are associated with each other), may also be used. Alternatively, for example, the layout decision model 212 that is generated by performing machine learning, using training data generated by using newspaper print pages created in a manner such that a specific layout condition is satisfied, may be used to decide the layout of a newspaper print page of another layout condition.

The layout decision section 202 may decide the layout of articles by using any other technique. For example, the layout decision section 202 may decide the layout of articles in accordance with a predetermined rule such as arranging articles in order of importance, or alternatively, may decide the layout in accordance with a user's operation. Further, the layout decision section 202 may decide the layout of articles by using two or more techniques. In this case, the user may be made to select a layout to be adopted from among layouts decided by the respective techniques.

Further, as described above, in the information processing apparatus 2 in accordance with the present example embodiment, the adjustment section 203 may make the adjustment by expanding the assignment area decided by the layout decision section 202 until the outer periphery of the assignment area reaches a delimitation position indicated in the layout condition 213. With this configuration, it is possible to achieve an example advantage of being capable of making an adjustment to obtain a layout with a superior appearance in which articles are aligned with the delimitation positions, in addition to the example advantage achieved by the information processing apparatus 1 in accordance with the first example embodiment. Further, since the assignment area is expanded, there is no concern that part of the article lies off the assignment area and cannot be displayed.

### Flow of Layout Assistance Method

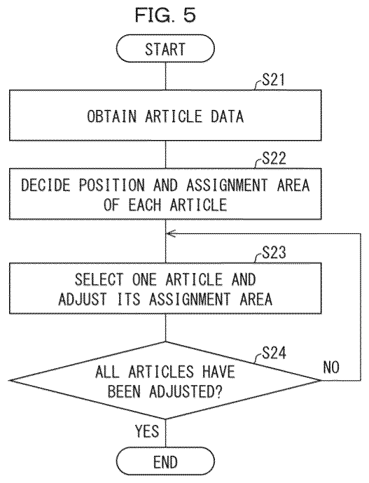

The following description will discuss the flow of a layout assistance method carried out by the information processing apparatus 2 with reference to FIG. 5. FIG. 5 is a flowchart illustrating the flow of the layout assistance method.

In S21, the data obtaining section 201 obtains the article data 211. Then, in S22, the layout decision section 202 decides, using the layout decision model 212, the position and the assignment area of each article indicated in the article data 211 obtained in S21.

In S23, the adjustment section 203 selects one article the layout of which has been decided in S22, and adjusts the assignment area of the article so that the layout condition 213 is satisfied. Then, in S24, the adjustment section 203 determines whether or not the adjustment has been completed for all of the articles the layout of which has been decided in S22. The process of FIG. 5 ends when it is determined to be YES in S24, whereas the process returns to S23 when it is determined to be NO in S24.

After laying out the articles and adjusting the assignment areas in S23, or after determining to be YES in S24, the information processing apparatus 2 may lay out each constituent element (the headline, a photo, the main text, etc.) included in each article that has been laid out. The layout method of the constituent elements of the articles will be described with reference to a third example embodiment described later.

The adjustment section 203 may carry out the adjustment in consideration of details of an adjustment made to an adjacent article. For example, assume that the adjustment section 203 makes an adjustment to the article A1 illustrated in 301 of FIG. 3, and then, makes an adjustment to the article A2 adjacent to the article A1. In this case, it is desirable that the adjustment section 203 make an adjustment of the article A2 as long as the article A2 does not overlap the assignment area of the article A1. For example, the adjustment section 203 may determine a row that is within the assignment area of the article A1 after the adjustment and is located at the bottom edge, and may set the top edge of a row directly below the row located at the bottom edge, as the position of the top edge of the article A2. Similarly, when carrying out the adjustment of the adjacent article A3, which is placed to the right of the article A1 after the adjustment, the adjustment section 203 may adjust the left edge of the article A3 to the position of the left edge of a text line that is present to the right of the rightmost text line in the assignment area of the article A1 after the adjustment.

Thus, in the information processing apparatus 2 in accordance with the present example embodiment, the adjustment section 203 may adjust the assignment area of one of two adjacent articles, and then expand the assignment area of the other article up to the outer periphery of the adjusted assignment area of the one article. This can eliminate an unnecessary gap between adjacent elements, so that it is possible to achieve an example advantage of being capable of making an adjustment to obtain a layout with a superior appearance, in addition to the example advantage achieved by the information processing apparatus 1 in accordance with the first example embodiment.

It should be noted that the process of expanding the assignment area “up to the outer periphery” includes, in addition to expanding the assignment area such that no gap is left between adjacent articles (i.e., until the outer peripheries of both adjacent articles partially coincide with each other), expanding the assignment area such that a gap having a predetermined width (e.g., referring to FIG. 3, a gap having a width of the space SP, a gap having a width of one text line or several text lines, a space having a width of a row gap, etc.) is left between adjacent articles.

### Third Example Embodiment

Similarly to the second example embodiment, also in a third example embodiment, an example will be described in which the object area of a layout is a print page of a newspaper. The difference between the second example embodiment and the third example embodiment is that, in the third example embodiment, adjusted is the assignment area of each constituent element (the headline, a photo, and the main text, etc.) included in an article of a newspaper. Of course, a layout assistance method and the like described in the third example embodiment are not limited to the layout of constituent elements of an article on a print page of a newspaper, and may be applied to the layout of any elements in any object area. Therefore, the “print page of a newspaper” in the following description can be read as any “object area”, and the “constituent elements of an article” in the following description can be read as any “elements” (elements to be arranged in an object area).

### Outline

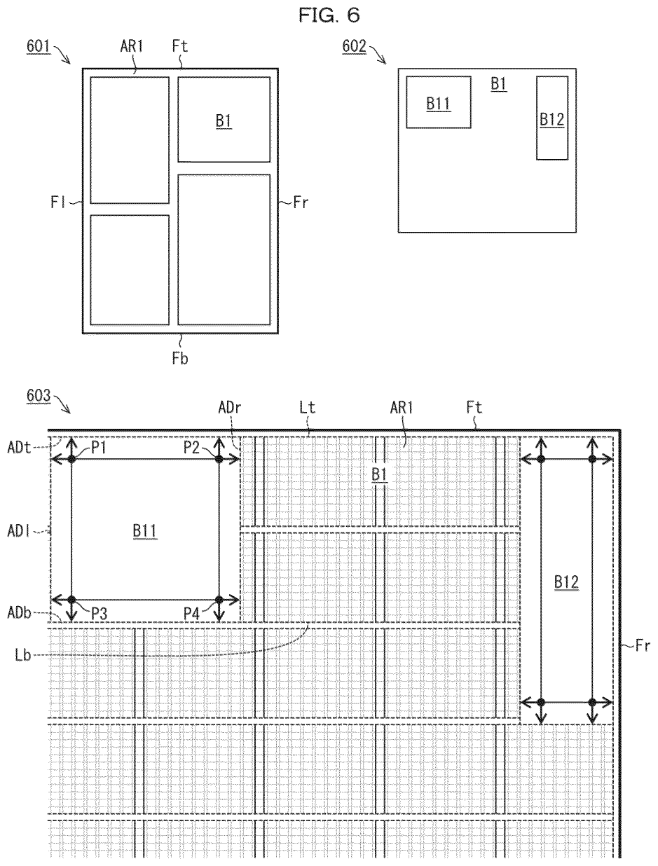

The following description will discuss the outline of a layout assistance method in accordance with the present example embodiment with reference to FIG. 6. FIG. 6 is a diagram illustrating an example of a layout adjustment carried out by using the layout assistance method in accordance with the present example embodiment (hereinafter, referred to as “the present method”). More specifically, in FIG. 6, 601 denotes an example of a layout of articles on a newspaper print page, 602 denotes an example of a layout of constituent elements of an article, and 603 denotes an example of a layout adjustment of constituent elements of an article.

FIG. 6 illustrated in the example of 601 that four articles are laid out in an area AR1 having the top edge, the bottom edge, the left edge, and the right edge defined by frame lines Ft, Fb, Fl, and Fr, respectively, and out of these articles, an article located at the upper right edge is an article B1. The layout of the articles may be generated in the same manner as in the second example embodiment, or may be generated manually by a user's operation. Further, after generating the layout of the articles, an adjustment similar to that in the second example embodiment may be made.

In the present method, the position and the assignment area of each constituent element of each of the articles that have been laid out are decided. FIG. 6 illustrates in 602 the position and the assignment area of a photo B11 and those of a headline B12 decided according to the present method. Here, the photo B11 and the headline B12 are constituent elements of the article B1, which is one of four articles that have been laid out.

In the present method, after the positions and the assignment areas of the constituent elements of the article are decided in this way, the layout of each constituent element (more specifically, the assignment area occupied by each constituent element) is adjusted so that a predetermined layout condition set to the area AR1 is satisfied. In the example of FIG. 6, the following four layout conditions are set.
(1) The top edge of each constituent element coincides with a typeface (top) of a ruled-off square defined in the area AR1.
(2) The bottom edge of each constituent element coincides with a typeface (bottom) of a ruled-off square defined in the area AR1.
(3) The left edge of each constituent element coincides with a line face (left) of a text line defined in the area AR1.
(4) The right edge of each constituent element coincides with a line face (right) of a text line defined in the area AR1.

In these layout conditions (1) to (4), the typefaces (top, bottom) of a ruled-off square and the line faces (right, left) of a text line serve as delimitation positions of the assignment areas of the constituent elements of the article. Herein, the term “typeface” refers to four faces (sides) defining a ruled-off square (G in FIG. 3) which receives one letter. The term “line face” refers to four faces (sides) defining a text line.

In FIG. 6, 603 denotes an example of an adjustment of the assignment areas of the photo B11 and the headline B12, which are constituent elements of the article B1. In 603, points P1 to P4 indicate four vertexes of a rectangular assignment area that has been assigned to the photo B11 before the adjustment. Broken lines ADt, ADb, ADl, and ADr indicate the top edge, the bottom edge, the left edge, and the right edge of the assignment area after the adjustment, respectively.

As illustrated in 603 in FIG. 6, the broken line ADt is aligned over the broken line Lt, which indicates the top edge of the row, and accordingly, the top edge of the row coincides with the top face of the typeface, which satisfies the abovementioned condition (1). The broken line ADb is aligned over the broken line Lb, which indicates the bottom edge of the row, so that the bottom edge of the row coincides with the bottom face of the typeface, which satisfies the abovementioned condition (2). The broken line ADl coincides with the left edge of the line face, which satisfies the abovementioned condition (3). The broken line ADr coincides with the right edge of the line face, which satisfies the abovementioned condition (4).

After the adjustments to the assignment areas of the photo B11 and the headline B12 as described in the foregoing, the remaining assignment area of the article B1 is set as the assignment area of the sentences of the article B1. This completes the laying out of the constituent elements of the article B1.

Regarding the layout conditions (3) and (4) described above, similarly to the second example embodiment, adjustments in the lateral direction may be carried out in a manner such that the edges of the assignment area after the adjustment do not extend inside the ruled-off squares G. That is, also in adjustments in the lateral direction in accordance with the present example embodiment, the assignment area may be adjusted to include therein the spaces SP between text lines or may be adjusted not to include therein the spaces SP between text lines.

In the present method, by carrying out the adjustments as described in the foregoing, a layout that satisfies the layout conditions is automatically generated. This achieves labor savings in generating a layout. Although it is also possible to have a layout satisfy the layout conditions at an initial step of generation of the layout of constituent elements of an article, in such a case, it is necessary to apply a layout technique that is specialized for a specific layout condition, and this disadvantageously reduces the versatility.

In this respect, the present method does not require a precise layout at the initial step of the generation of the layout of constituent elements of an article, so that it is possible to apply a highly versatile layout technique that is not specialized for a specific layout condition.

### Conditions for Adjustment

Similarly to the layout adjustment of articles, it is necessary to determine conditions for adjustment in advance also in the adjustments to constituent elements of an article. For example, a condition that an adjustment is made in such a manner as to expand the assignment area of an article while minimizing the amount of adjustment may be determined in advance. In addition to this condition, when the outer periphery of the assignment area before the adjustment is in a line gap or a row gap, a condition that an adjustment is made in such a manner as to reduce the assignment area may be determined in advance.

Further, an assignment area that is adjacent to the outer periphery of the assignment area of the article may be adjusted with reference to this outer periphery. For example, the constituent element B11 illustrated in FIG. 6 faces the outer periphery (top edge) of the assignment area of the article B1. Thus, the top edge of the assignment area of the constituent element B11 may be adjusted to the position of the outer periphery (top edge) of the assignment area of the article B1. Thus, it is possible to provide a layout with a superior appearance in which the constituent elements located at the outer periphery of its article are arranged along the outer periphery.

### Configuration of Information Processing Apparatus 2A

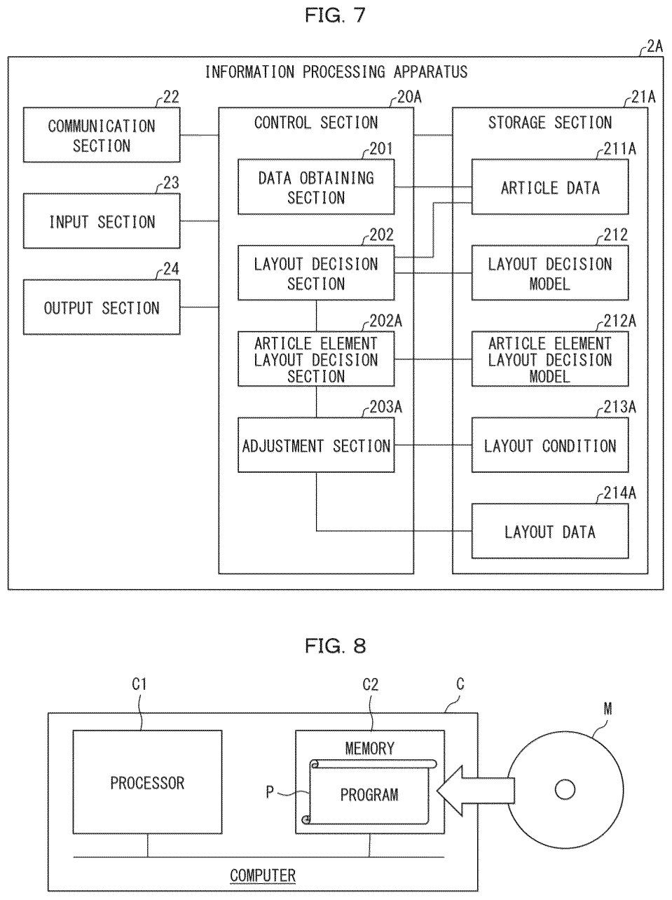

The following description will discuss the configuration of an information processing apparatus 2A in accordance with the present example embodiment with reference to FIG. 7. FIG. 7 is a block diagram illustrating the configuration of the information processing apparatus 2A. As illustrated in the figure, the information processing apparatus 2A includes: a control section 20A that centrally controls each section of the information processing apparatus 2A; and a storage section 21A that stores various kinds of data used by the information processing apparatus 2A. Similarly to the information processing apparatus 2, the information processing apparatus 2A also includes a communication section 22, an input section 23, and an output section 24.

The control section 20A includes a data obtaining section 201 and a layout decision section 202 similarly to the control section 20, and also includes an article element layout decision section (layout decision means) 202A and an adjustment section (adjustment means) 203A. The storage section 21A stores a layout decision model 212 similarly to the storage section 21, and also stores article data 211A, an article element layout decision model 212A, a layout condition 213A, and layout data 214A.

The article data 211A indicates each article to be arranged in a layout and each constituent element of each article. In addition to information indicating the articles and the constituent elements of the articles to be arranged in a newspaper print page, the article data 211A may include various kinds of information associated with the articles and the constituent elements of the articles. For example, the article data 211A may include various kinds of information for use in deciding the layout of the articles, similarly to the article data 211. Further, the article data 211A may include various kinds of information for use in deciding a layout of the constituent elements of an article, that is, information set as explanatory variables of the article element layout decision model 212A to be described later.

The article element layout decision section 202A decides the layout of constituent elements of articles on a newspaper print page, that is, the position and the assignment area of each constituent element of each article to be arranged in the newspaper print page. Specifically, the article element layout decision section 202A decides, using the article element layout decision model 212A, the position and the assignment area of each constituent element of each article indicated in the article data 211A obtained by the data obtaining section 201.

The article element layout decision model 212A is a model that is generated by performing machine learning based on a relationship between (i) various kinds of information associated with an arrangement of a constituent element of an article, serving as explanatory variables, and (ii) the position and the assignment area in which the constituent element of the article is to be arranged, serving as objective variables. By receiving as input the various kinds of information associated with an arrangement of a constituent element of an article indicated in the article data 211A, the article element layout decision model 212A outputs the information indicating the position and the assignment area in which the constituent element is to be arranged.

Here, the explanatory variables include at least the shape and size of an article. For example, the coordinates or the width and height of the four corners of an article may be used as the explanatory variables. The coordinates or the width and height of the four corners of an article are decided by the layout decision section 202.

Further, the explanatory variables may include information indicating the contents, size, and volume of each constituent element (e.g., the text, a photo, the headline, etc.) included in an article. In addition, for example, information indicating the category or the importance of an article may be included in the explanatory variables. These pieces of information may be included in the article data 211A. The abovementioned objective variables may be information indicating the position and the assignment area of each constituent element of each article. For example, the position coordinates indicating the positions of the four corners of each constituent element may be used as the objective variables.

As described above in the item “Outline”, the present method does not require a precise layout at the initial step of generation of the layout of the constituent elements of the articles, so that it is possible to apply a highly versatile article element layout decision model 212A that is not specialized for a specific layout condition. For example, the article element layout decision model 212A that is generated by performing machine learning, using training data generated by using actual newspaper print pages with different layout conditions (i.e., data of the newspaper print pages in which the abovementioned explanatory variables and the abovementioned objective variables are associated with each other), may also be used. Alternatively, for example, the article element layout decision model 212A that is generated by performing machine learning, using training data generated by using newspaper print pages created in a manner such that a specific layout condition is satisfied, may be used to decide the layout of a newspaper print page of another layout condition.

The article element layout decision section 202A may decide the layout of articles by using any other technique. For example, the article element layout decision section 202A may decide the layout of constituent elements of an article in accordance with a predetermined rule such as placing a headline at the upper right edge and placing a photo at the upper left edge, or alternatively, may decide the layout in accordance with a user's operation. Further, the article element layout decision section 202A may decide the layout of constituent elements of each article, using two or more techniques. In this case, the user may be made to select a layout to be adopted from among layouts decided by the respective techniques.

The adjustment section 203A makes an adjustment to the assignment area decided by the article element layout decision section 202A so that a predetermined layout condition 213A set to the newspaper print page is satisfied. Then, the adjustment section 203A generates layout data 214A in which this adjustment is reflected in the layout decided by the article element layout decision section 202A.

The layout conditions and the adjustment method are as described under the item “Outline” described above. For example, the adjustment section 203A may make the adjustment by expanding the assignment area decided by the article element layout decision section 202A until the outer periphery of the assignment area reaches a delimitation position indicated in the layout condition 213A.

The adjustment section 203A may adjust the assignment area of each article decided by the layout decision section 202 in the same manner as in the second example embodiment. That is, the adjustment section 203A may carry out both the adjustment to the assignment area of an article and the adjustment to the assignment area of a constituent element of an article. Further, the adjustment section 203A may be configured to make an adjustment to the assignment area of a constituent element of an article, and the adjustment section 203 configured to make an adjustment to the assignment area of an article may be separately provided.

As described in the foregoing, the information processing apparatus 2A in accordance with the present example embodiment includes: the article element layout decision section 202A that decides, for each constituent element of each article (elements to be arranged in a layout) to be arranged in a newspaper print page, which is an object area of a layout, the position and the assignment area of the constituent element in the newspaper print page; and the adjustment section 203A that makes an adjustment to the assignment area decided by the article element layout decision section 202A so that a predetermined layout condition 213 set to the newspaper print page is satisfied. Thus, with the information processing apparatus 2A in accordance with the present example embodiment, it is possible to achieve an example advantage of being capable of achieving labor savings in generating a layout.

### Flow of Layout Assistance Method

The flow of a layout assistance method carried out by the information processing apparatus 2A is generally the same as that illustrated in FIG. 5. In the layout assistance method carried out by the information processing apparatus 2A, the data obtaining section 201 obtains article data 211A in S21. After the layout decision section 202 decides the position and the assignment area of each article in S22, the article element layout decision section 202A decides the position and the assignment area of each constituent element of each article.

Subsequently, in S23, the adjustment section 203A adjusts the assignment area of a constituent element of an article, and in S24, it is determined whether or not the adjustment of all the constituent elements of the article has been completed. When it is determined to be YES in S24, constituent elements of another article is adjusted. When the adjustment of every constituent element of every article is completed, the layout assistance method carried out by the information processing apparatus 2A ends.

The adjustment section 203A may carry out the adjustment in consideration of details of an adjustment made to an adjacent constituent element. For example, the adjustment section 203A may adjust the assignment area of one of two adjacent constituent elements, and then expand the assignment area of the other constituent element up to the outer periphery of the adjusted assignment area of the one constituent element. Further, the adjustment section 203A may adjust the assignment area of a constituent element that is adjacent to the outer periphery of the article with reference to the position of this outer periphery. Further, the adjustment section 203A does not necessarily need to adjust the assignment areas of all constituent elements included in an article; the adjustment section 203A may adjust the assignment area of an constituent element(s) having the determined shape, such as a photo and the headline, and lay out sentences included in the article on the remaining assignment area of the article.

### Variations

Any subject may carry out each process described in the above example embodiments, and is not limited to the examples described above. In other words, it is possible to construct a layout assistance system having the same functions as those of the information processing apparatuses 1, 2, and 2A with use of a plurality of apparatuses capable of mutual communication. For example, as for the block diagrams of FIGS. 1, 4, and 7, a layout assistance system having the same functions as those of the information processing apparatuses 1, 2, and 2A can be constructed by dispersedly providing, in a plurality of apparatuses, respective blocks illustrated in FIGS. 1, 4, and 7.

### Software Implementation Example

Some or all of the functions of each of the information processing apparatuses 1, 2, and 2A may be implemented by hardware such as an integrated circuit (IC chip), or may be alternatively implemented by software.

In the latter case, the information processing apparatuses 1, 2, and 2A is implemented by, for example, a computer that executes instructions of a program (assistance program) that is software implementing the foregoing functions. FIG. 8 illustrates an example of such a computer (hereinafter, referred to as “computer C”). The computer C includes at least one processor C1 and at least one memory C2. The memory C2 stores a program P for causing the computer C to operate as the information processing apparatuses 1, 2, and 2A. The processor C1 of the computer C retrieves the program P from the memory C2 and executes the program P, so that the functions of the information processing apparatuses 1, 2, and 2A are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C may further include a communication interface via which data is transmitted to and received from another apparatus. The computer C can further include an input/output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the above example embodiments can be described as below. Note, however, that the present invention is not limited to the following supplementary notes.

### Supplementary Note 1

An information processing apparatus including: layout decision means for deciding, for each of elements to be arranged in an object area of a layout, a position and an assignment area of the element in the object area; and adjustment means for making an adjustment to the assignment area so that a predetermined layout condition set to the object area is satisfied.

### Supplementary Note 2

The information processing apparatus according to Supplementary note 1, wherein the layout decision means decides the position and the assignment area of the element by using a layout decision model generated by performing machine learning based on a relationship between explanatory variables and objective variables, the explanatory variables being various kinds of information associated with an arrangement of the element, the objective variables being the position and the assignment area in which the element is to be arranged.

### Supplementary Note 3

The information processing apparatus according to Supplementary note 1 or 2, wherein the adjustment means makes the adjustment by expanding the assignment area until an outer periphery of the assignment area reaches a delimitation position indicated in the layout condition.

### Supplementary Note 4

The information processing apparatus according to any one of Supplementary notes 1 to 3, wherein the adjustment means adjusts an assignment area of one of two adjacent elements out of the elements, and then expands an assignment area of the other up to an outer periphery of the adjusted assignment area of the one.

### Supplementary Note 5

A layout assistance method including: deciding, by at least one processor, for each of elements to be arranged in an object area of a layout, a position and an assignment area of the element in the object area; and making, by the at least one processor, an adjustment to the assignment area so that a predetermined layout condition set to the object area is satisfied.

### Supplementary Note 6

A layout assistance program for causing a computer to function as:
layout decision means for deciding, for each of elements to be arranged in an object area of a layout, a position and an assignment area of the element in the object area; and adjustment means for making an adjustment to the assignment area so that a predetermined layout condition set to the object area is satisfied.

### Additional Remark 3

Furthermore, some of or all of the above example embodiments can also be expressed as follows. An information processing apparatus including at least one processor, the at least one processor including: a layout decision process of deciding, for each of elements to be arranged in an object area of a layout, a position and an assignment area of the element in the object area; and an adjustment process of making an adjustment to the assignment area so that a predetermined layout condition set to the object area is satisfied.

Note that the information processing apparatus may further include a memory, which may store therein a program for causing the at least one processor to carry out the layout decision process and the adjustment process. Alternatively, the program may be stored in a computer-readable, non-transitory, tangible storage medium.

### REFERENCE SIGNS LIST

1, 2, 2A Information processing apparatus
11,202 Layout decision section
12, 203, 203A Adjustment section
20, 20A Control section
21, 21A Storage section
22 Communication section
23 Input section
24 Output section
201 Data obtaining section
202A Article element layout decision section

What is claimed is:

1. An information processing apparatus comprising at least one processor, the processor carrying out:
a layout decision process of deciding, for each of elements to be arranged in an object area of a layout, a position and an assignment area of the element in the object area; and
an adjustment process of making an adjustment to the assignment area so that a predetermined layout condition set to the object area is satisfied.

2. The information processing apparatus according to claim 1, wherein in the layout decision process, the at least one processor decides the position and the assignment area of the element by using a layout decision model generated by performing machine learning based on a relationship between explanatory variables and objective variables, the explanatory variables being various kinds of information associated with an arrangement of the element, the objective variables being the position and the assignment area in which the element is to be arranged.

3. The information processing apparatus according to claim 1, wherein in the adjustment process, the at least one processor makes the adjustment by expanding the assignment area until an outer periphery of the assignment area reaches a delimitation position indicated in the layout condition.

4. The information processing apparatus according to claim 1, wherein in the adjustment process, the at least one processor adjusts an assignment area of one of two adjacent elements out of the elements, and then expands an assignment area of the other up to an outer periphery of the adjusted assignment area of the one.

5. A layout assistance method comprising:
deciding, by at least one processor, for each of elements to be arranged in an object area of a layout, a position and an assignment area of the element in the object area; and
making, by the at least one processor, an adjustment to the assignment area so that a predetermined layout condition set to the object area is satisfied.

6. A non-transitory storage medium storing a layout assistance program for causing a computer to carry out:
a layout decision process of deciding, for each of elements to be arranged in an object area of a layout, a position and an assignment area of the element in the object area; and
an adjustment process of making an adjustment to the assignment area so that a predetermined layout condition set to the object area is satisfied.
